(19) United States
(12) Patent Application Publication
(10) Pub. No.: US 2016/0071100 A1
(43) Pub. Date: Mar. 10, 2016

(54) MECHANISM FOR AUTHORISING TRANSACTIONS CONDUCTED AT UNATTENDED TERMINALS

(71) Applicant: MasterCard International Incorporated, Purchase, NY (US)

(72) Inventors: James C. Noe, West Wickham (GB); Michael J. Cowen, London (GB); Sagitha George, Harrow (GB); David A. Roberts, Warrington (GB); Anouska Ladds, Caterham (GB)

(21) Appl. No.: 14/845,474

(22) Filed: Sep. 4, 2015

(30) Foreign Application Priority Data
Sep. 5, 2014 (GB) 1415720.0

(51) Int. Cl. G06Q 20/38

(52) U.S. Cl. CPC G06Q 20/3821

(57) ABSTRACT

Methods and systems for processing transactions initiated at unattended terminals using user devices without visible credentials, and providing services concerning such transactions, are disclosed. A first party issues a set of pseudo credentials for a user device responsive to authorisation request data concerning a transaction initiated with a second party using the user device and provides the pseudo credentials to the second party, who maps such pseudo credentials to real credentials of the user device acquired from the user device during the transaction. The pseudo credentials are also provided to a user of the user device who submits such pseudo credentials to the second party during a subsequent enquiry concerning the transaction. To authenticate the user device, the second party requests authorisation from the first party using the pseudo credentials.

### CROSS REFERENCE TO RELATED APPLICATIONS

This application claims foreign priority to United Kingdom Patent Application 1415720.0, filed 5 Sep. 2014, the complete disclosure of which is expressly incorporated herein by reference in its entirety for all purposes.

### FIELD OF THE INVENTION

The present invention relates generally to transaction processing methods and associated systems. In particular, but not exclusively, the invention relates to methods and systems for processing and servicing transactions carried out through unattended terminals, and, more specifically, in the context of transactions initiated by user devices whose device credentials are not visible.

### BACKGROUND OF THE INVENTION

A number of payment devices (e.g., payment cards) are set up in such a way that end-users (e.g., a cardholder, a consumer, a customer, a user, or the like) may not know their payment devices' credentials, such as a primary account number (PAN), an expiry date, a card verification code (such as a card verification code printed on the back of a payment card (CVC2)), a card sequence number, and/or the like. Examples of such payment devices include payment cards with no PAN printed or embossed on the card (e.g., some Maestro cards), stickers, and various mobile implementations, e.g., mobile phones (or other mobile devices), key fobs, watches with Near-Field-Communication (NFC) capabilities, and the like. Further, some payment devices (e.g., a mobile phone) may provide, to a payment terminal, credentials that differ from the credentials associated with the account funding payment transactions initiated from the device.

Although a user of the payment device may not know these payment device credentials, a merchant typically is able to read these and other payment device credentials from the payment device itself using a reader device, such as a payment card reader. Thus, a consumer is able to use the payment device to pay for goods or services in a device present transaction without personally providing credentials of the payment device to the merchant, for example, by simply presenting the payment device at a Point-of-Sale (POS) terminal (e.g., Tap and Go™). However, in certain situations, for example, in a remote transaction (card/payment device not present transactions), the consumer may be required to provide payment device credentials in order to access merchant's services or goods, such as to enquire about a particular past transaction or access a service provided by the back-end system of the merchant. For example, a commuter using his or her contactless payment device to pay for transit services may need to contact a respective transit authority to access his or her travel history, dispute a particular charge, and/or sign up for a service with the transit authority. In order to respond to such a request from the consumer, the merchant typically requests the consumer to provide his or her payment device credentials to authenticate the payment device (consumer's account). However, if the consumer cannot obtain such credentials from the payment device itself, he or she might not be able to comply with the merchant's request, and thus would not be able to access that merchant's services or goods, such as the travel history or dispute a particular charge.

FIG. 1 shows a known multi-party payment transaction system 100 for enabling payment-by-card or similar transactions by a customer 110 (e.g., a cardholder, a user, and the like) at a merchant 120 (e.g., a transit agency). An issuer 150, usually a financial institution such as a bank, establishes for the customer 110 a customer's account 114 and stores and updates data in association with that account, for example, in a database 152. The issuer 150 also provides the customer 110 with a payment device 112, such as a credit or debit card and/or its equivalent in association with the customer's account 114.

A payment transaction is initiated when the customer 110 uses the payment device 112 to tender a payment for a purchase from the merchant 120, usually at a POS terminal (not shown). A series of exchanges between the parties depicted in FIG. 1 is then required to complete the transaction. These exchanges may generally be viewed as being conducted in four stages: (1) a card-reader interaction, (2) authorisation, (3) clearing, and (4) settlement.

At the card-reader interaction stage, the merchant 120 captures (reads, receives, or the like) payment device credentials from the payment device 112. For example, the customer 110 may tap his or her contactless payment card or an NFC-enabled mobile payment device against an NFC enabled reader of the POS terminal to allow the POS terminal to read the payment device credentials, including consumer's account information, from a chip or a secure element embedded in the payment device 112.

During the authorisation stage, the identity of the customer's account, the authenticity of the payment device 112, and the availability of funds in the customer's account 114 are confirmed. The merchant 120 transmits electronically the information captured from the payment device to the transaction processing computers of a merchant's bank 130 (or an acquirer/an acquiring bank) to request authorisation of the transaction. The request may also include the transaction amount, such as the purchase amount.

A payment system network 140, such as the MasterCard™ payment-processing network, facilitates communications between the computers of the merchant's bank 130 and the computers of the issuer 150, which in turn determine whether to authorise or decline the payment. If the issuer 150 authorises the payment, it decreases availability of funds on the consumer's account 114 accordingly and issues an authorisation code to the merchant 120. The authorisation code is transmitted back to the merchant 120 via the payment system network 140 and the merchant's bank 130.

During the clearing stage, the payment system network 140 facilitates transmission of the transaction data between the parties to ensure that all parties have the necessary and correct information for settling the transaction, and that the transaction is settled according to the payment guidelines and rules established by the payment system network 140. Finally, during the settlement stage, the payment system network 140 facilitates the exchange of funds so that the appropriate parties are paid in relation to the transaction.

In the context of repeated transactions for small amounts with a single merchant, such as with transit payments (trains, tube, ferry, parking, tolls, and the like), a somewhat different approach to processing payment transactions is often employed. More specifically, the individual charges (e.g., individual fares) are typically small, and thus the merchant 120, such as a transit agency, may elect to aggregate all transit transactions involving the payment device 112 over a certain period of time (a few hours, a day, a period of days, a certain number of transactions, and the like)—called an aggregation period—before clearing and settling all the transactions for the total amount. In other words, the individual charges are aggregated over the aggregation period and then settled in accordance with the rules of the payment system network 140.

For example, consider a scenario of a customer 110 entering a transit system by tapping the payment device 112 at a point of entry to the transit system (such as transit agency's validator, gate, POS terminal, or any other suitable entry point). Provided that the payment device 112 is valid and is not currently blocked by the transit agency from travel (e.g., for a prior non-payment), the customer 110 is typically allowed to travel prior to the transit agency 120 seeking authorisation from the issuer 150. It is the nature of the transit services that a large number of travellers (commuters, and the like) need to enter and exit the transit system in short periods of time. At the same time, transit agencies often suffer from lack of high speed and/or reliable communication infrastructure. Accordingly, to accommodate consumer demand for transit services in a timely manner, consumers are generally allowed to travel before the authorisation is obtained from the issuer 150.

Whilst the customer 110 is travelling, payment credentials read from the payment device 112 at the point of entry are incorporated by the transit agency 120 into the respective transaction and passed to the merchant's bank 130 as a part of a transit aggregation request. The merchant's bank 130 in turn passes the transit aggregation request to the payment system network 140, which passes it to the issuer 150. The issuer 150 evaluates whether a new aggregation period may be started and provides its response to the transit agency 120 via the payment network 140 and merchant's bank 130.

If the transit agency 120 receives an authorisation response indicating that the aggregation request has been approved, the transit agency 120 now may receive further taps from the payment device 112 around the transit network and calculate charges (fares) based on where, when, and which mode of transport the customer 110 used. Upon expiration of the aggregation period (e.g., a certain charge amount has been accumulated by the customer 110, a certain time period has passed, and the like), the transit agency 120 submits a singular transaction for an amount totalling all charges accumulated by the customer 110 during the aggregation period for clearing and settling in accordance with the standard clearing and settlement procedures established by the payment system network 140.

Alternatively, a transit agency 120 may use a deferred authorisation scheme, in accordance with which the customer 110 is charged for each transit transaction individually. However, due to the above-described constraints experienced by the transit agencies, the authorisation of each transaction is performed after the customer 110 has been allowed to travel. Regardless of whether the transit agency 120 employs the aggregation or deferred authorisation scheme, however, the transit agency captures payment device credentials at the point of entry into the transit network.

One problem associated with transactions using a payment device without visible payment device credentials is not being able to access certain merchant's services associated with a payment transaction conducted at an unattended terminal (e.g., transit terminals, vending machines, rental terminal, such as a bike rental terminal, parking payment terminals, and the like) post-transaction. This problem is particularly acute in the context of transit services. More specifically, as described above, the transit agency obtains payment device credentials via a reader of an unattended POS terminal at the entry point and grants the consumer access to the transit system, without requiring the consumer to personally provide the payment device credentials. Thus, the consumer does not need to know the payment device credentials, such as its PAN, to travel using the transit system when everything proceeds in accordance with a normal routine. However, should the consumer wish to access a self-service system of the transit agency, for example, to enquire about his or her past transactions, to dispute a charge, to register with the transit agency, or the like, the transit agency will require the consumer to provide the payment device credentials, such as a PAN, to confirm or authenticate the payment device and consumer's account and to tally the enquiry with the past transactions. Since the consumer is unable to access his or her payment device credentials on the payment device (e.g., no PAN printed or embossed on the payment device, or credentials provided by the payment device provided to a reader differ from the ones displayed), he or she is not able to respond to the merchant's request. Thus, the consumer will be prevented from, for example, viewing a transaction history, disputing a particular charge, registering with the transit agency, removing a block from the payment device, and the like. The transit agency is, however, typically unaware of whether a particular payment device has visible payment device credentials. Consequently, transit agencies do not provide any special accommodations to users of payment devices, which do not have visible payment device credentials.

Therefore, a problem with the current approach to processing payment transactions at unattended terminals is that transit agencies and other types of merchants are not able to provide certain services or goods to users of payment devices that do not have payment device credentials visible thereon. Further, since these merchants have no means to discriminate payment devices that do have their credentials visible thereon, the merchants cannot monitor or remedy the situation. Furthermore, in many such environments, such as a transit service, the merchant has no means to communicate with the consumer at the point of service, as the terminal is unattended and/or the consumer has already left the terminal by the time the authorisation request is submitted. Thus, although the removal of visible credentials from contactless payment devices is designed to improve security of payment transactions, simplify their processing, and/or prevent their users from conducting certain types of transactions, e.g., e-commerce transactions, the actual effect is that users of such devices may not be able to enjoy services or goods that they should be able to enjoy and would have enjoyed if they used a more traditional payment device, such as a credit or debit card that has a PAN, a CVC2, and an expiry date printed or embossed thereon.

There is therefore a need to provide an improved method and/or system for processing transit payment transactions that enable users of payment devices that do not have one or more credentials visible thereon to use back-end services provided by transit agencies, including but not limited to accessing history transactions and disputing charges, even when such users do not know credentials associated with their payment devices. More generally, there is a need to provide a method and/or a system for processing payment transactions at unattended terminals that are adept to successfully process payment transactions initiated by a payment device that does not have one or more credentials visible thereon, whilst enabling a respective merchant to authenticate requests from a user of such a device subsequent to the payment transaction and to enable such users to access all services and goods available at the merchant in association with the payment transaction. There is a further need to enable issuers to prohibit use of certain payment devices for a certain type of transactions, without encroaching on user's ability to use the payment device for other types of transactions.

### SUMMARY OF THE INVENTION

The described embodiments of the invention provide for methods and systems for processing transactions initiated at unattended terminals by users who do not have access to the real credentials of user devices they use to initiate transactions.

In one embodiment, the present disclosure provides a computer-implemented method for processing transactions associated with a first party, the method comprising: receiving authorisation request data from the first party concerning a transaction initiated at an unattended terminal of the first party, the authorisation request data comprising real credentials of a user device used to initiate the transaction; issuing one or more pseudo credentials for a user associated with the real credentials; transmitting authorisation response data responsive to the authorisation request data toward the first party, the authorisation response data comprising the one or more pseudo credentials; and communicating the one or more pseudo credentials to the user.

In some example embodiments, the one or more pseudo credentials are issued for the user to be used to query the first party concerning at least the transaction.

In some example embodiments, the one or more pseudo credentials are issued upon determining that the one or more pseudo credentials are required for the user device.

In some example embodiments, the one or more pseudo credentials are determined to be required if one of more of the real credentials are not accessible to the user on the device.

In some example embodiments, the one or more pseudo credentials have been pre-generated prior to receiving the authorisation request data.

In some example embodiments, the method further comprises: generating the one or more pseudo credentials after receiving the authorisation request data.

In some example embodiments, the method further comprises: storing the one or more pseudo credentials in association with the real credentials.

In some example embodiments, the use of the one or more pseudo credentials is restricted to the first party, a type of the first party, a type of the transaction, and/or a time frame.

In some example embodiments, the one or more pseudo credentials comprise a pseudo primary account number, a pseudo expiry date, a pseudo card verification code, a pseudo name, a pseudo address, and/or one or more pseudo security codes.

In some example embodiments, the communicating step comprises: sending an e-mail message comprising the one or more pseudo credentials to an e-mail address associated with the user; sending a text message comprising the one or more pseudo credentials to a phone number associated with the user; providing a computer-generated voice notification comprising the one or more pseudo credentials to the phone number associated with the user; and/or making the one or more pseudo credentials available for access by the user via an application used by the user to access data concerning a user's account.

In some example embodiments, the application is a web-based application or an application downloaded on at least one device of the user.

In some example embodiments, the user device is a contactless device.

In some example embodiments, the user device is a payment card having no primary account number printed or embossed thereon, a key fob, a key tag, a sticker, a smartcard, or an NFC enabled mobile device.

In some example embodiments, the unattended terminal is a transit agency terminal, a parking terminal, a rental terminal, or a vending machine.

In some example embodiments, the method is performed by a third party that generates and maintains pseudo credentials at least on behalf of a second party associated with the user device.

In some example embodiments, the third party generates and maintains pseudo credentials on behalf of a plurality of second parties, the plurality of second parties comprising the second party.

In some example embodiments, the method further comprises: receiving an enquiry authorisation request data from the first party concerning the user device, the enquiry comprising the one or more pseudo credentials; matching the one or more pseudo credentials to the real credentials of the user device; updating the enquiry authorisation request data with the one or more pseudo credentials; and transmitting the updated enquiry authorisation request data toward the second party.

In some example embodiments, the method further comprises: receiving, from the second party, an enquiry response data responsive to the updated enquiry authorisation request data; updating the enquiry response data with the one or more pseudo credentials; and transmitting the updated enquiry response data toward the first party.

In some example embodiments, the method is performed by a second party associated with the user device.

In some example embodiments, the method further comprises: receiving, from the first party, an enquiry authorisation request data concerning the user device and comprising the one or more pseudo credentials; matching the one or more pseudo credentials to the real credentials of the user device; accessing data related to the enquiry authorisation request data using the real credentials to generate an enquiry response data responsive to the enquiry authorisation request data; and transmitting the enquiry response data toward the first party.

In some example embodiments, the second party is an issuer and the user device is a payment device issued by the issuer.

In some example embodiments, the third party is a payment system network.

In some example embodiments, the method further comprises: receiving an enquiry from the first party concerning the user device, the enquiry comprising the one or more pseudo credentials; and matching the one or more pseudo credentials to the real credentials.

In some example embodiments, the one or more pseudo credentials are issued to replace one or more of the real credentials that are not accessible to the user on the user device.

In some example embodiments, the transaction is a payment transaction, the first party is a merchant, the user device is a payment device, and/or the user is a customer of the merchant.

In some example embodiments, a system for processing a payment transaction initiated at an unattended terminal is provided, the system comprising memory for storing real credentials in association with pseudo credentials for a plurality of user devices and at least one processor configured to perform any of the methods described above.

In some example embodiments, a non-transitory computer readable medium is provided, the medium having stored instructions thereon which, when executed by at least one processor of a computer system, cause the computer system to carry out any of the methods described above.

In some example embodiments, a processing hub for processing a transaction initiated at an unattended terminal associated with a first party is provided. The processing hub comprises memory for storing real credentials in association with pseudo credentials for a plurality of user devices, the memory storing instructions; and at least one processor configured, when executing the instructions stored in the memory, to cause the processing hub to carry out any of the methods described above.

In another embodiment, the present disclosure provides a computer-implemented method for processing transactions at a server, the method comprising: receiving, from an unattended terminal associated with a first party, real credentials of a user device used to initiate a transaction at the unattended terminal; generating authorisation request data concerning the transaction, the authorisation request data comprising the real credentials; transmitting the authorisation request data toward a second party associated with the user device; receiving, from the second party, authorisation response data responsive to the authorisation request data and comprising one or more pseudo credentials; and storing the one or more pseudo credentials mapped to the real credentials of the device.

In some example embodiments, the method further comprises: processing the transaction in accordance with the authorisation response data.

In some example embodiments, the method further comprises: receiving an enquiry concerning the user device; and processing the enquiry using at least the one or more pseudo credentials.

In some example embodiments, the method further comprises: receiving device credentials in association with the enquiry; and matching the received device credentials to the one or more pseudo credentials.

In some example embodiments, the enquiry is one of an account status enquiry or a debt recovery transaction.

In some example embodiments, the processing the enquiry step further comprises: generating enquiry authorisation request data in association with the enquiry for transmission toward the second party, the enquiry authorisation request comprising the one or more pseudo credentials; and receiving, from the second party, enquiry authorisation response data responsive to the enquiry authorisation request data.

In some example embodiments, the processing of the enquiry step further comprises: removing the user device from a blocked list, wherein the blocked list identifies user devices forbidden to access services of the first party; providing a transaction history of the user device with the first party; providing data concerning the transaction; and/or registering a user of the user device with the first party.

In some example embodiments, the method further comprises: receiving the real credentials of the user device when the user device is used to initiate a subsequent payment transaction with the first party; and associating the subsequent transaction with the one or more pseudo credentials.

In some example embodiments, the authorisation response data authorises starting of an aggregation time period.

In some example embodiments, the one or more pseudo credentials comprise a pseudo primary account number, a pseudo expiry date, a pseudo card verification code, a pseudo name, a pseudo address, and/or one or more pseudo security codes.

In some example embodiments, the user device is a contactless device.

In some example embodiments, the payment device is a payment card having no primary account number printed or embossed thereon, a key fob, a key tag, a sticker, a smartcard, and/or an NFC enabled mobile device.

In some example embodiments, the processing of the transaction step comprises: placing the user device on a blocked list to prevent the user device from being used subsequently to the transaction to access services of the first party if the authorisation response data indicates that the transaction is declined.

In some example embodiments, the transaction is a payment transaction, the first party is a merchant, the user device is a payment device, the user is a customer of the merchant, and/or the second party is an issuer of the payment device.

In some example embodiments, the unattended terminal is a transit agency terminal, a parking terminal, a rental terminal, or a vending machine.

In some example embodiments, the first party is a transit agency.

In some example embodiments, a system for processing a payment transaction initiated at an unattended terminal is provided, the system comprising memory for storing real credentials in association with pseudo credentials for a plurality of user devices and at least one processor configured to perform any of the methods described above.

In some example embodiments, a non-transitory computer readable medium is provided, the medium having stored instructions thereon which, when executed by at least one processor of a computer system, cause the computer system to carry out any of the methods described above.

In some example embodiments, a processing hub for processing a transaction initiated with a first party is provided, the hub comprising memory for storing data associated with transactions initiated with the first party, the memory further storing instructions; and at least one processor configured, when executing the instructions stored in the memory, to cause the processing hub to carry out any of the methods described above.

In some example embodiments, the processing hub is configured to process transactions initiated at a plurality of unattended terminals associated with the first party.

In some example embodiments, the processing hub configured to receive real credentials acquired by an unattended terminal from a user device when a transaction is initiated.

In another embodiment, the present disclosure provides a computer-implemented method for processing, by a third-party processing hub, transactions initiated at unattended terminals, the method comprising: receiving authorisation request data from a first party concerning a transaction initiated by a user device, the authorisation request data comprising real credentials of the user device; forwarding the authorisation request data to second party associated with the payment device; issuing one or more pseudo credentials for a user associated with the real credentials; receiving, from the second party, authorisation response data responsive to the authorisation request data; updating the authorisation response data with the one or more pseudo credentials; transmitting the updated authorisation response data toward the first party; and communicating the one or more pseudo credentials to the user.

In some example embodiments, the method further comprises: mapping the one or more pseudo credentials to the real credentials.

In some example embodiments, the method further comprises: sending an e-mail message comprising the one or more pseudo credentials to an e-mail address associated with the user; sending a text message comprising the one or more pseudo credentials to a phone number associated with the user; providing a computer-generated voice notification comprising the one or more pseudo credentials to the phone number associated with the user; and/or making the one or more pseudo credentials available for access by the user via an application used by the user to access data concerning a user's account.

In some example embodiments, the issuing one or more pseudo credentials step comprises: generating the one or more pseudo credentials after receiving the authorisation request data and storing the one or more pseudo credentials in association with the user device; and/or retrieving, based on the real credentials, the one or more pseudo credentials from memory associated with third-party processing hub.

In some example embodiments, a system for processing, by a third-party processing hub, transaction-related enquiries is provided, the system comprising memory for storing data that maps pseudo credentials to real credentials and at least one processor configured to perform any of the methods described above.

In some example embodiments, a non-transitory computer readable medium is provided, the medium having stored instructions thereon which, when executed by at least one processor of a computer system, cause the computer system to carry out any of the methods described above.

In some example embodiments, a third-party processing hub for facilitating processing transactions initiated at unattended terminals is provided, the third-party processing hub comprising memory for storing data that maps pseudo credentials to real credentials, and further storing instructions; and at least one processor configured, when executing the instructions stored in the memory, to cause the third-party processing hub to carry out any of the methods described above.

In another embodiment, the present disclosure provides a computer-implemented method for processing, by a third-party processing hub, transaction-related enquiries, the method comprising: receiving, from a first party, enquiry authorisation request data concerning a user device and comprising one or more pseudo credentials; matching the one or more pseudo credentials to real credentials of the user device; updating the enquiry authorisation request data with the real credentials; and transmitting the updated enquiry authorisation request toward a second party.

In some example embodiments, the method further comprises: receiving, from the second party, enquiry response data responsive to the updated enquiry authorisation request data; updating the enquiry response data with the one or more pseudo credentials; and transmitting the updated enquiry response data toward the first party.

In some example embodiments, the transaction is a payment transaction, the first party is a merchant, the user device is a payment device, the user is a customer of the merchant, and/or the second party is an issuer of the payment device.

In some example embodiments, a system for processing, by a third-party processing hub, transaction-related enquiries is provided, the system comprising memory for storing data that maps pseudo credentials to real credentials (and/or real credentials to pseudo credentials) and at least one processor configured to perform any of the methods described above.

In some example embodiments, a non-transitory computer readable medium is provided, the medium having stored instructions thereon which, when executed by at least one processor of a computer system, cause the computer system to carry out any of the methods described above.

In some example embodiments, a third-party processing hub for facilitating processing of transactions initiated at unattended terminals is provided. The third-party processing hub comprises memory for storing data that maps pseudo credentials to real credentials (and/or real credentials to pseudo credentials), and further storing instructions; and at least one processor configured, when executing the instructions stored in the memory, to cause the third-party processing hub to carry out any of the methods described above.

In another embodiment, the present disclosure provides a user device comprising: at least one processor; and memory storing real credentials of the user device, the memory further storing instructions, which when executed by the least one processor cause the user device to carry out a method comprising: sharing real credentials with an unattended terminal of a first party to initiate a transaction with the first party; receiving, from a second party, different from the first party, one or more pseudo credentials associated with the real credentials in response to the transaction being initiated; and providing the one or more pseudo credentials to a user of the user device.

In some example embodiments, the first party is a merchant, the user device is a mobile device configured to serve as a payment device, and/or the user is a customer of the merchant.

In some example embodiments, the second party is an issuer of the payment device or a third-party processing hub servicing the issuer.

### BRIEF DESCRIPTION OF THE DRAWINGS

Embodiments of the present invention will be described, by way of example only, with reference to the accompanying drawings, in which:

FIG. 1 shows a known multi-party payment transaction system for enabling payment-by-card transactions;

FIGS. 2A and 2B show a multi-party payment transaction system for processing payment transactions at unattended terminals, according to some embodiments of the present invention;

FIGS. 3A and 3B illustrate flow diagrams of a method for processing payment transactions initiated at unattended terminals, according to some embodiments of the present invention;

FIG. 4 shows a flow diagram of a method for responding to an enquiry from a merchant, according to some embodiments of the present invention;

FIG. 5 illustrates a flow diagram of a method for processing, by a merchant, a payment transaction at an unattended payment terminal, according to some embodiments of the present invention;

FIG. 6 shows a flow diagram of a method for responding to a consumer enquiry submitted to a merchant, according to some embodiments of the present invention;

FIG. 7 depicts a system that facilitates processing of payment transactions at unattended terminals, according to some embodiments of the present invention; and

FIG. 8 shows examples of communications for informing a consumer about pseudo credentials issued for consumer's payment device, according to some embodiments of the present invention.

### DETAILED DESCRIPTION

Embodiments of the invention provide improved methods and systems for processing transactions at unattended terminals. In particular, the disclosed methods and systems enable parties or entities to provide services, previously unavailable, to users who conduct transactions at unattended terminals of such parties (entities) using devices with device credentials that are not visible or available to their users.

The disclosed embodiments improve on known payment processing methods and systems by introducing and incorporating pseudo credentials, in association with real credentials, into the processing of payment transactions involving payment devices that do not have one or more credentials visible thereon or that provide credentials different from credentials associated with an account funding payment transactions. By generating, processing, and using pseudo credentials in such transactions and to process such transactions, in the manner described herein, a mechanism that allows merchants to authenticate their consumers post-transaction, and thus to respond to their enquiries, is provided, resulting in an improved user experience and additional user services being enabled, and removes unintended limitations associated with the use of such payment devices in card-not-present transactions (payment device-not-present transactions).

Embodiments are described below primarily with reference to transit transactions. However, although this is a particularly preferred application of the disclosed embodiments, the embodiments are in no way restricted to this application. In particular, the context of transit transactions is illustrative and the described embodiments and the described techniques are more generally applicable to processing transactions at unattended terminals, such as parking meters, vending machines, rental machines (e.g., bike rental stations), or any other services or goods machines that require a payment for their services or goods. More generally, the described techniques are applicable to processing a transaction initiated at an unattended terminal of a certain entity (party) using a user device having associated credentials, readable by the unattended terminal, in particular, where a user of the user device may want to subsequently query the entity (party) concerning the transaction or related information. Therefore, embodiments according to the invention are not limited by the specific embodiments depicted in the figures and, rather, are limited only by the scope of the claims that follow.

As described herein, the term “payment card” refers to a card, such as a smart card, a credit card, a debit card, a charge card, a membership card, a frequent flyer card, a promotional card, prepaid cards, gift cards, stickers, and the like. All may be used as a method of payment for performing a transaction. Further, the term “payment device” refers to any suitable payment card or any suitable payment device that is capable of identifying itself to a terminal (NFC reader or the like), including but not limited to a key fob, a tag, a watch, an NFC enabled mobile device (such as a mobile phone, a tablet, a personal digital assistant, etc.), or the like.

Also, as described herein, the term “payment device credential(s)” refers to a primary account number (PAN) (generally a number code, typically of 14 or 16 digits, that identifies the issuer of the payment device and the account, and includes a check digit as an authentication device), a card verification code (e.g. an EMV Application Cryptogram, a card verification cord typically printed on the back of a card (CVC2), a card verification value, a card security code, a personal security code, and a card identification number), an expiry date associated with a payment device, or a combination of the above, but may also refer to a customer's name, a security code, an address, and the like. Further the terms “consumer,” “user,” “cardholder,” “customer,” and “account holder” are interchangeable in the context of the present disclosure.

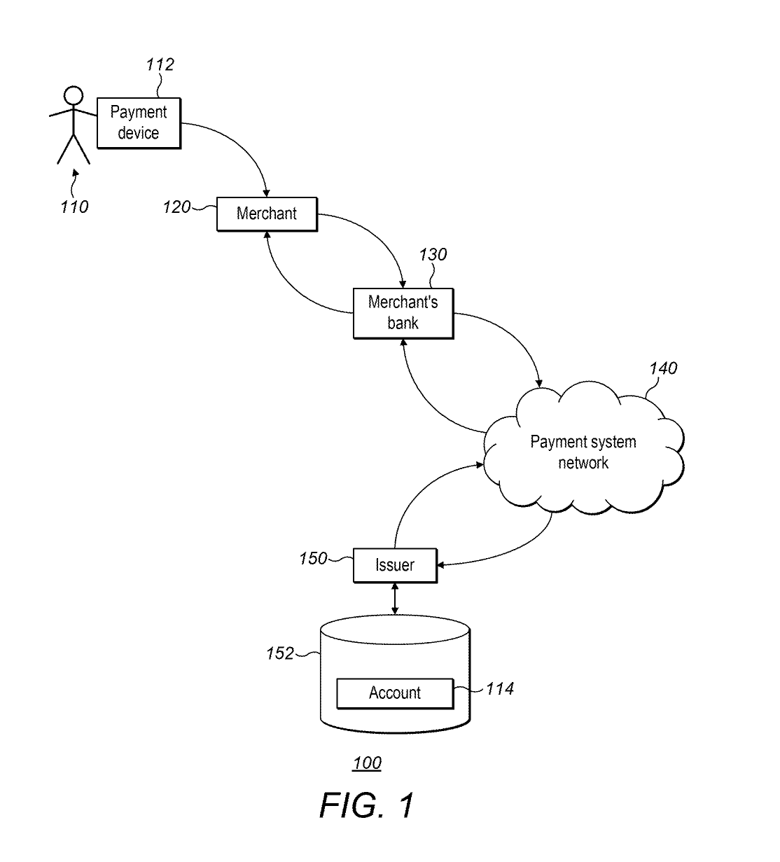

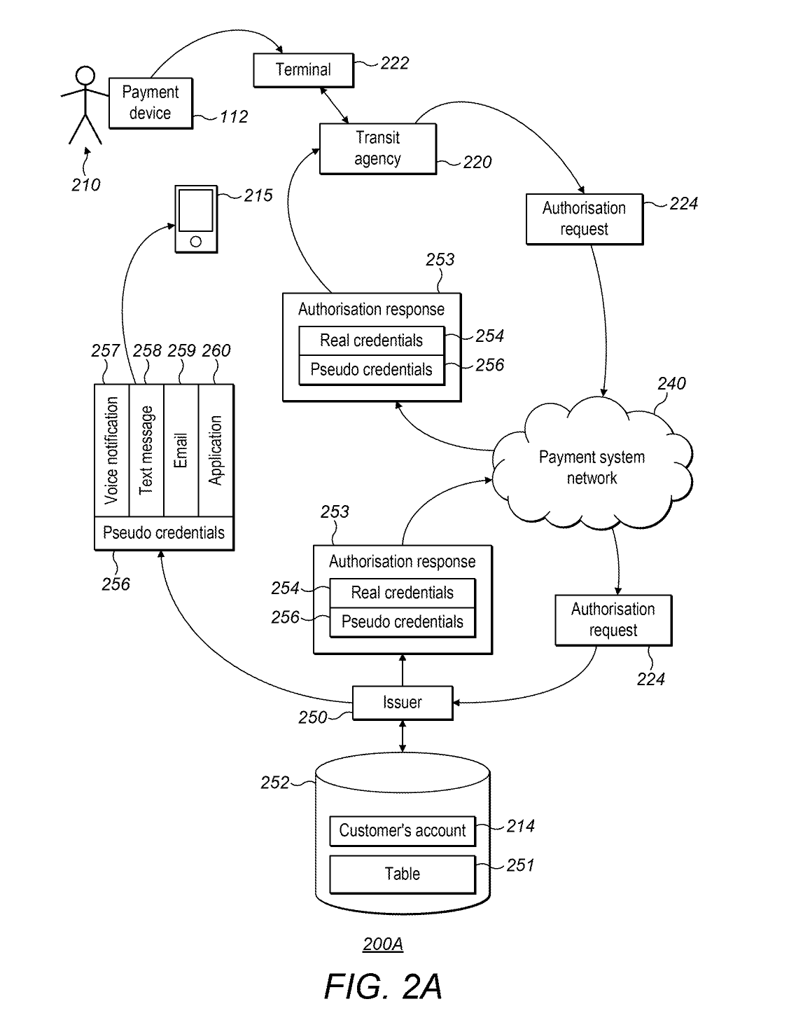

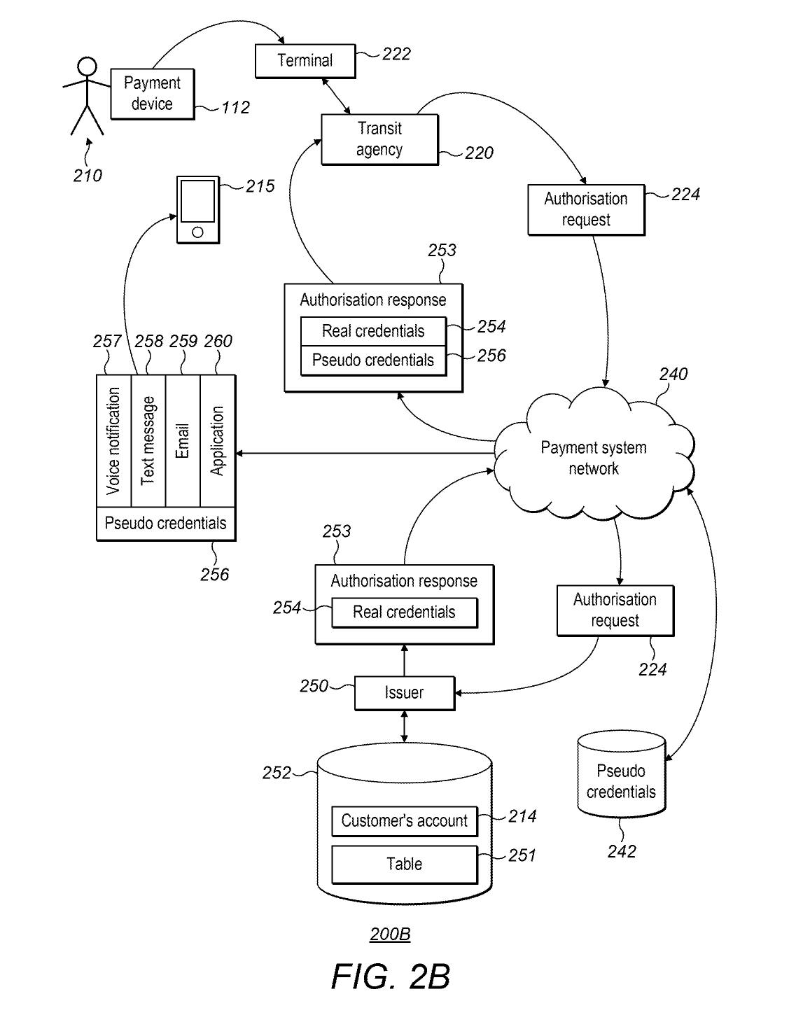

FIG. 2A shows a multi-party transaction system 200A according to some embodiments of the present invention. The multi-party transaction system 200A generally includes the same parties as the multi-party transaction system 100 discussed with respect to FIG. 1: a customer 210, a transit agency 220 (a merchant), an acquirer (not shown), a payment system network 240, and an issuer 250. The transit agency 220 comprises one or more unattended terminals 222, which are in communication with central computer(s)/server(s) of the transit agency 220 via wireless or wired connections. The customer 210 initiates a payment transaction at an unattended terminal 222, for example, by tapping a payment device 212 against or swiping the payment device 212 through a reader (not shown) of the unattended terminal 222, enabling the unattended terminal 222 to read (receive, capture, or otherwise obtain) payment device credentials from the payment device 112. The transit agency 220 subsequently generates an authorisation request 224, including the payment device credentials, which is transmitted via the payment system network 240 to the issuer 250.

Upon receiving the authorisation request 224, the issuer 250 determines whether pseudo credentials should be issued for the customer 210 associated with the payment device 212. As discussed herein, credentials may, for example, be required to authenticate a customer's account (customer's payment device) should the customer 210 contact the transit agency 220 concerning the payment transaction. However, the customer 210 may have a payment device that does not show one or more credentials associated with the device (e.g., the credentials are not embedded or printed on the device), and thus may not know the one or more payment device credentials. If the customer 210 is unable to provide the credentials associated with the payment device 212 to the transit agency 220, he or she will not be able to access the services he or she desires.

The issuer 250 however knows what kind of payment devices it has issued to its customers. Thus, it is in the position to determine whether pseudo credentials should be provided for the customer 210 responsive to the authorisation request 224. For example, the issuer 250 may maintain a database 252 with table(s) 251 including records listing payment devices associated with a customer's account 214. For each of the payment devices, the table(s) 251 may maintain a record of whether and what pseudo credentials (e.g., PAN, CVC2, expiry date, security code, address, and/or the like) should be issued for that payment device 212 when authorising a payment transaction initiated by that payment device 212. Alternatively, the issuer 250 may maintain information concerning types of the payment devices it provided to its consumers and what pseudo credentials should be issued for each type of the payment device. The skilled person would appreciate that other implementations may be used as well. Generally, how the issuer 250 maintains and/or determines whether pseudo credentials should be issued may depend on particular preferences of the issuer 250, its technical specifications and capabilities, and/or agreements with its customers and/or other parties, such as the payment system network 240.

In some embodiments, pseudo credential(s) issued by the issuer 250 correspond to (issued to replace) non-visible credentials of the payment device 212. For example, if the payment device is a payment card that has a name and an expiry date printed thereon, the issuer 250 will issue a pseudo PAN and pseudo CVC2, but not a name or an expiry date. In some other embodiments, however, when at least one of the payment device credentials is not visible, the issuer 250 issues a full set of pseudo credentials for the payment device 212. Yet, in some other embodiments, even if the payment device 212 shows all of the associated credentials, the issuer issues a set of pseudo credentials, for example, to be used in association with a specific transit agency 220 only.

If the issuer 250 deems that no pseudo credentials are needed to complete the payment transaction, it processes the authorisation request in a regular manner, such as described with respect to FIG. 1. However, if the issuer 250 deems that one or more pseudo credentials are required, in addition to determining whether the payment transaction is to be authorised or denied, the issuer 250 issues one or more pseudo credentials 256. The one or more pseudo credentials 256 are stored in association with the customer 210, the payment device 212, and/or the consumer's account 214, for example, in the issuer's database 252.

In some embodiments, issuing one or more pseudo credentials by the issuer 250 includes generating the one or more pseudo credentials 256 in response to receiving the authorisation request 224, in real-time. Yet, in some other embodiments, the issuer 250 pre-generates the one or more pseudo credentials 256 and stores them in the database 252 in association with the customer 210, the payment device 212, and/or the customer's account 214, prior to receiving the authorisation request 224. Thereafter, the issuer 250 retrieves (obtains, accesses, or the like) the one or more pseudo credentials 256 from the database 252 in response to the authorisation request 224. That is, in such embodiments, issuing the one or more pseudo credentials 256 by the issuer 250 includes obtaining the one or more pseudo credentials that have been pre-generated in association with the customer 210, the payment device 212, and/or the consumer's account 214.

In some embodiments, the issuer 250 can issue different sets of pseudo credentials, for example, for different merchants, different types of merchants, different types of transactions, different time periods, and so on. When the customer 210 has more than one payment device 212 in association with a single customer's account (e.g., a joint account with two or more associated credit cards; a debit card and a mobile device, and the like), the pseudo credentials issued by the issuer 250 are unique to each PAN and Sequence Number combination.

The issuer 250 includes the issued pseudo credentials 256 into an authorisation response 253 that it generates to inform the transit agency 220 about transaction's authorisation/denial, e.g., by populating relevant message fields. In particular, the generated authorisation response 253 includes an authorisation number (if the payment transaction is authorised), the one or more pseudo credentials 256, one or more credentials 254 from the authorisation request 224, and other data. The one or more credentials 254 are the credentials that the transit agency has captured from the payment device and typically are the “real” credentials of the payment device. The authorisation response 253 is then transmitted to the transit agency 220 via the payment system network 240. Upon receipt of the authorisation response 253, the transit agency 220 saves the one or more pseudo credentials 256, in association with the payment transaction, as the credentials for authenticating the payment device at a later time and/or as the credentials to be used to confirm identity of the consumer's account and/or the customer 210.

The issuer 250 also communicates, or otherwise provides, the one or more pseudo credentials 256 to the customer 210 so as to enable the customer 210 to authenticate the payment device 112 when contacting the transit agency 220 concerning the payment transaction. In some embodiments, this communication is performed in parallel with the transmission of the authorisation response 253. For example, as shown in FIG. 2A, the one or more pseudo credentials 256 may be communicated to the customer 210 as a part of a computer-generated voice notification 257 addressed to a phone number associated with the consumer's account 214, as a text (e.g., SMS) message 258 addressed to a phone number associated with the consumer's account 214, and/or as an e-mail 259 addressed to an e-mail address associated with the consumer's account 214. Further, the one or more pseudo credentials 256 may be communicated to the customer 210 through a proprietary application 260 of the issuer 250 that enables the customer 210 to access his or her account information at the issuer 250. Such an application may be installed on consumer's mobile or stationary device, such as a smart phone, a tablet, a desktop computer, and the like. Alternatively, the application 260 may be web-based (e.g., a Java Applet) and accessed by the user via, for example, an Internet browser.

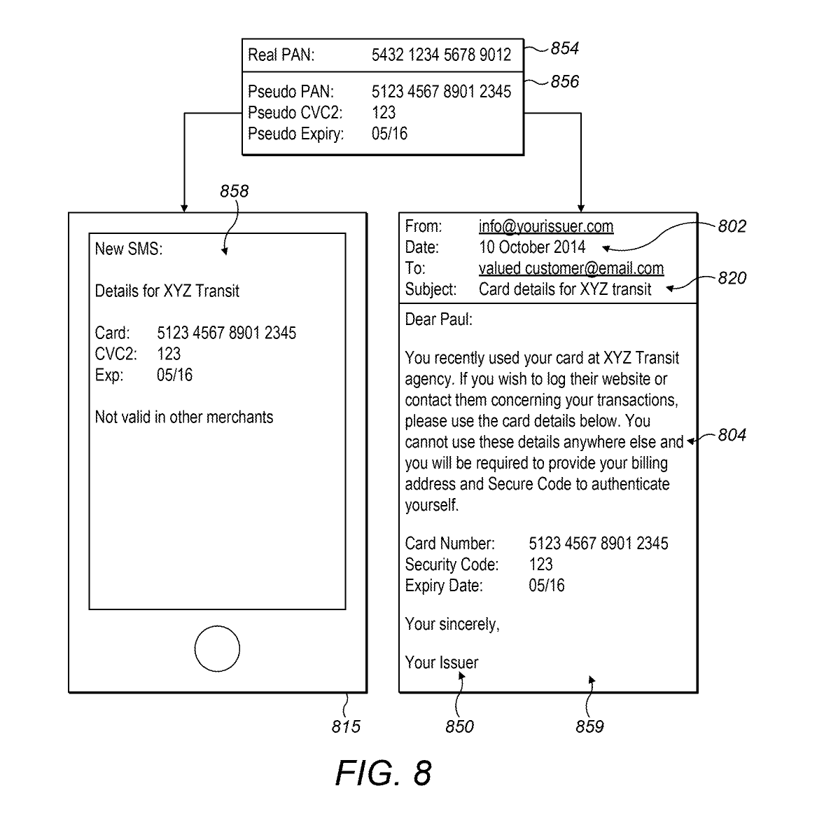

FIG. 8 shows examples of a text message 858 and an e-mail message 859 informing the customer 210 about pseudo credentials 856 issued for that consumer in association with a payment transaction. In addition to the pseudo credentials 856, the notification to the customer 210 may identify the merchant 820, the date of the transaction 802, the issuer 850, and/or include an indication 804 of whether the pseudo credentials 856 are restricted to a single merchant, single type of merchant, a single transaction, and/or a particular time frame. Different consumers may select different preferred types of communication; a single consumer may select more than one type of communications; and more than one communication of a single type may be provided to a single consumer, e.g., two e-mails to two different e-mail addresses associated with a single consumer.

A person skilled in the art would appreciate that other communication tools may be used to communicate the one or more pseudo credentials 256 to the customer 210. Generally, how and in what form the one or more pseudo credentials 256 are communicated to the customer 210 may depend on the customer preferences set with the issuer 250, technical capabilities of customer's devices, preferences, rules, and/or technical capabilities of the issuer 250, and the like.

Returning to FIG. 2A, once the customer 210 receives the one or more pseudo credentials 256, the customer 210 is able to contact the transit agency 220 concerning the payment transaction and related services using the received pseudo credentials 256 to authenticate the payment device 212 and/or customer's account 214. The customer 210 may contact the transit agency 220, for example through the agency's website or call centre, where the consumer will need to enter the one or more pseudo credentials 256 to enable the transit agency to authenticate the consumer's request. If the one or more pseudo credentials do not form the full set of credentials associated with the payment device 212, for example, when some of the real credentials are printed on the payment device 212, the customer 210 may use the real credentials in combination with the received one or more pseudo credentials 256, depending on what credentials are requested by the transit agency 220. In addition, the transit agency 220 may request the customer 210 to provide additional credentials to confirm his/her identity and/or identity of the account, such as, but not limited to, a billing address and/or a security code.

FIG. 2B shows a variation of a multi-party transaction system for processing payment transactions, according to some embodiments. More specifically, FIG. 2B shows a multi-party transaction system 200B, which generally includes the same components and provides for the same functionalities as the multi-party transaction system 200A shown in and discussed with respect to FIG. 2A. However, unlike the multi-party transaction system 200A, in which the issuer 250 is responsible for issuing the one or more pseudo credentials 256 and maintaining relevant data, in the multi-party transaction system 200B, the payment system network 240 (such as MasterCard™) or another payment transactions facilitator performs such functions. In other words, the payment system network 240 acts on behalf of the issuer 250 with respect to the issuance and maintenance of pseudo credentials 256 for account holders of the issuer 250 that require such credentials.

In some embodiments, the issuer 250 subscribes to such on-behalf services of the payment system network 240 and identifies all account holders that would require pseudo credentials to the payment system network 240 beforehand. The payment system network 240 maintains data concerning all its on-behalf service subscribers and their respective account holders who require pseudo credentials, for example, in a respective database 242. Thus, when the payment system network 240 receives an authorisation request concerning a payment transaction associated with one of its subscribers (as for example determined based on a PAN included in the request), it is able to determine whether one or more pseudo credentials 256 are required to enable provision of customer services to the respective consumer by the transit agency 220 post-transaction. In some embodiments, the procedure for determining whether pseudo credentials are required is performed in real time, using the core processing system of the payment system network 240. Other implementations may be used however as well, including, but not limited to, by using another software, application, module, or system that is called by the core processing system of the payment system network 240, applying batch processing, or using other tools. Thus, using, for example, the PAN from the authorisation request, the payment system network 240 is able to search its database 242 to determine whether the one or more pseudo credentials are required for the respective customer, and issue such pseudo credentials when the determination is positive.

When the payment system network 240 acts on behalf of the issuer 250, it generates, issues, provides, and/or maintains the pseudo credentials 256 generally in the same manner as the issuer 250 of the multi-party transaction system 200A described with respect to FIG. 2A. That is, the payment system network 240 may generate pseudo credentials in real time when the respective authorisation request is being processed, or such credentials may have been pre-generated and stored in the database 242, and the payment network system 240 merely accesses the credentials at the time of the authorisation request being processed. Further, similar to the issuer 250 of the multi-party transaction system 200A, the payment system network 240 of the multi-party transaction system 200B may generate, maintain, and issue multiple sets of pseudo credentials for a single customer's account, such as different pseudo credentials for different merchants, time periods, and the like.

After receiving an authorisation response 253 from the issuer 250, the payment system network 240 amends the authorisation response 253 by including the one or more pseudo credentials 256 it issued (generated or obtained), for example in predefined field(s) of the response, and then transmits the amended authorisation response 253 to the merchant 220. The payment system network 240 also provides the one or more pseudo credentials 256 to the customer 210 in the manner similar to the one of the issuer 250, as described with respect to FIG. 2A. Alternatively, in some embodiments, the payment system network 240 provides the one or more pseudo credentials 256 to the issuer 250, who in turn provides such pseudo credentials to the customer 210 in the manner described with respect to FIG. 2A.

In some embodiments, instead of (or in addition to) identifying accounts requiring pseudo credentials to the payment system network 240 in advance of respective payment transactions, the issuer 250 includes into the authorisation response 253 an indicator to inform the payment system network that one or more pseudo credentials 256 should be issued. In this scenario, it is not necessary for the payment network system 240 to determine whether the pseudo credentials are required, but rather the payment system network becomes aware of when pseudo credentials should be issued on per transaction basis.

When the customer 210 submits a post-transaction enquiry to the transit agency 220 concerning one or more payment transactions with the transit agency 220 and identifies his or her consumer's account 214 using the one or more pseudo credentials 256, the payment system network 240 acts as a translator. In particular, if the enquiry requires the transit agency 220 to communicate with the issuer 250 (for example, when a respective customer is not registered with the transit agency 220, and thus his/her account information must be authenticated), the transmit agency 220 submits (sends), to the payment system network 240, a request concerning the enquiry (such as an authorisation request) for transmitting it to the issuer 250. Before passing the request to the issuer 250, the payment system network 240 matches the one or more pseudo credentials 256 included in the request to the one or more real credentials 254, updates the request with the one or more real credentials, and submits the updated request to the issuer 250. Upon receiving a response to the request, the payment system network 240 performs a reverse action of substituting the one or more real credentials 254 with the one or more pseudo credentials 256, and then returns the updated response to the transit agency 220.

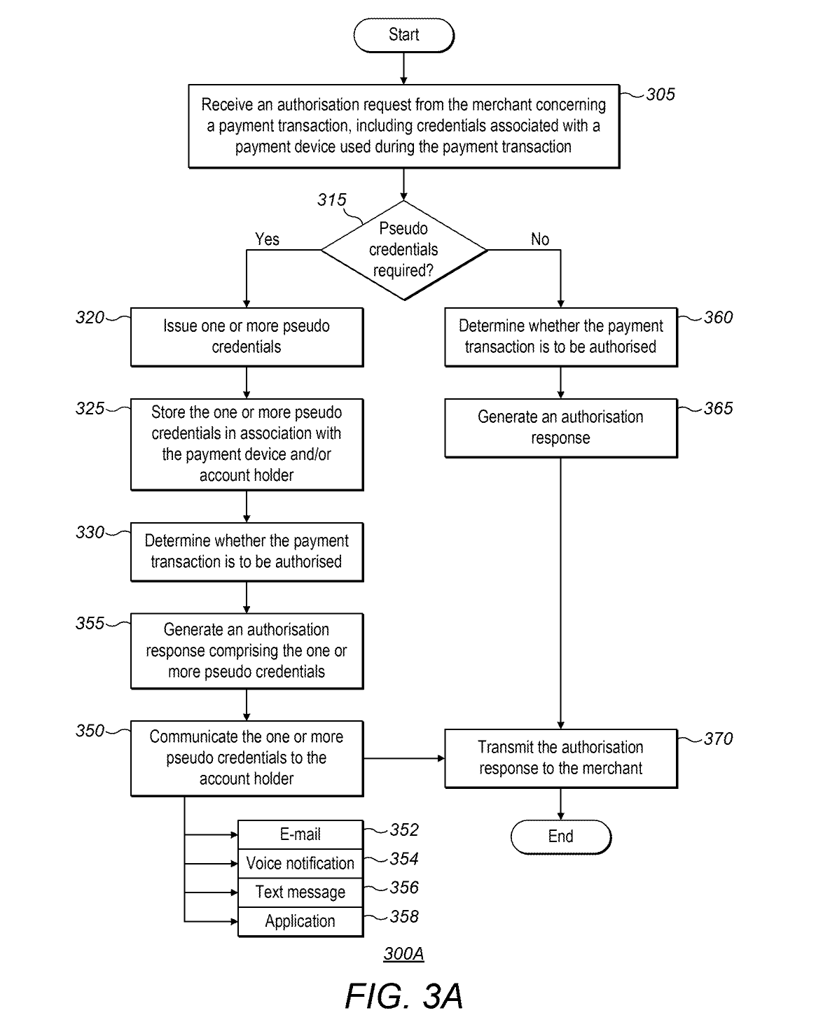

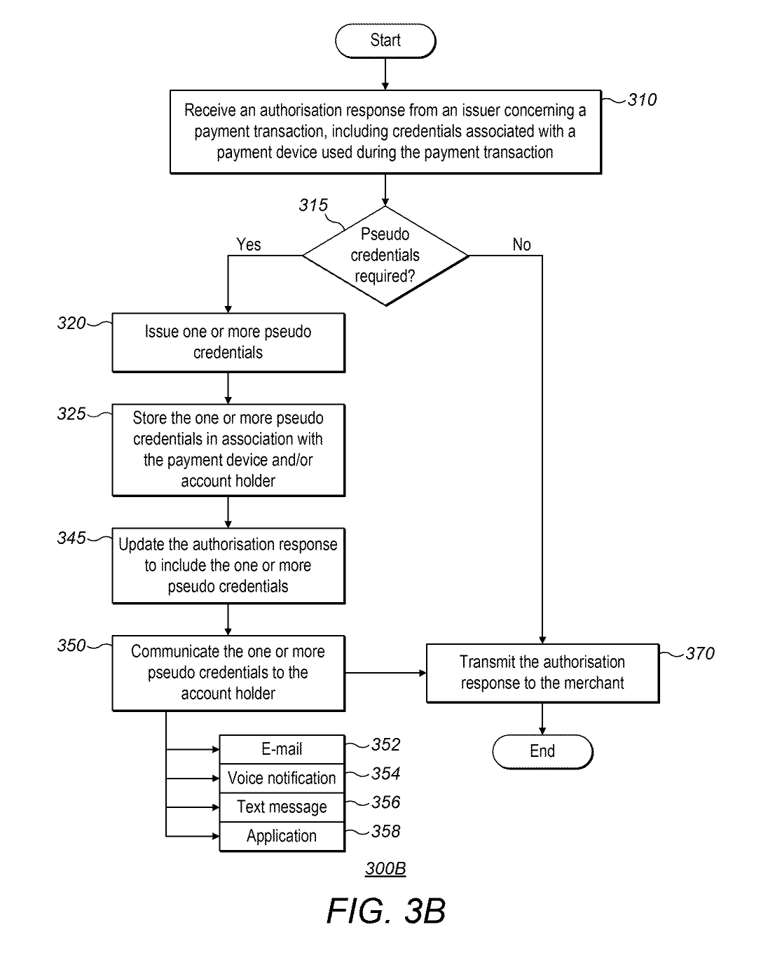

FIG. 3A illustrates a flow diagram of a method 300A for processing by an issuer (for example by and at a processing hub maintained by the issuer) payment transactions initiated at an unattended payment terminal, according to some embodiments. The method starts with step 305 where the issuer receives an authorisation request originating from a merchant concerning a payment transaction initiated at one of its unattended payment terminals. The authorisation request includes credentials associated with a payment device used to initiate the payment transaction which were obtained from the payment device by the terminal. The skilled person would appreciate that a full and/or complete set of payment device credentials is not required to be included in the authorisation request, as long as the included credentials (or their portions, e.g., a portion of PAN) are sufficient to enable the issuer to properly authenticate the payment device. That is, only certain credentials (e.g., key credentials specified by the issuer) may be included. Which credentials are included may be defined by an agreement between the merchant, the acquirer, the payment system network, and/or the issuer and/or by the rules established by the payment system network.

The authorisation request may further include the amount of the transaction and merchant's identification. The amount of the transaction may be the actual purchase amount, a pre-authorisation aggregation value, or a nominal value.

At step 315, the issuer determines whether pseudo credentials are required. As discussed herein, such pseudo credentials may be required when the consumer does not have access to some or all payment device credentials, such as when no PAN is printed on a payment card. If the issuer determines that no pseudo credentials are needed, the method proceeds to step 360, at which point the issuer determines whether to authorise the payment transaction. An authorisation response, indicating whether the transaction is authorised or declined is generated at step 365. In particular, if the issuer confirms the identity of the consumer, the authenticity of the payment device, and the availability of funds in the consumer's account, it issues an authorisation code, which it includes in the authorisation response. However, if the issuer is not able to confirm the identity of the consumer or authenticate the payment device, or the consumer does not have sufficient funds to cover the amount of the transaction, the issuer generates an authorisation response indicating that the payment transaction is to be denied (declined).

If at step 315, the issuer determines that pseudo credentials are required, the issuer, at step 320, issues one or more required pseudo credentials. As discussed herein, such pseudo credentials may be generated in real time, and thus then stored, at step 325, in association with an account holder (customer's account) identified by the credentials obtained from the payment device as defined in the authorisation request. However, as also discussed herein, in some embodiments, the one or more pseudo credentials are pre-generated and stored in the issuer's database prior to receipt of the authorisation request. In such embodiments, step 325 has been executed long before the authorisation request has been received, and step 320 comprises obtaining the one or more pseudo credentials from the issuer's database. If more than one set of pseudo credentials is stored in association with the customer's account, the issuer selects one of the sets, for example, randomly or based on the merchant, the merchant's type, the type of payment transaction, current time, and/or the like.

At step 330, the issuer determines whether to authorise the payment transaction and generates a corresponding message in a manner generally similar to that of step 365 discussed above. However, unlike step 365, the authorisation response generated at step 335, in addition to providing an indication as to whether the payment transaction is authorised or denied, includes the one or more pseudo credentials. The authorisation response may further include all or some of the credentials from the authorisation request and a sequence number to enable the merchant to identify the authorisation request responsive to which the authorisation response has been provided.

At step 350, the issuer communicates, or otherwise provides, the one or more pseudo credentials to the consumer. In particular, the issuer obtains (accesses, reads, receives, or the like) communication preferences of the consumer and information as to where communication(s) are to be sent, for example, by accessing the issuer's database and locating respective data in association with the customer's account. Depending on these preferences, the issuer generates an e-mail communication 352, a text message 356, a computer-generated voice notification 354, and/or an application data/message 358 and communicates the generated communication(s) to the consumer. Each generated communication includes the one or more pseudo credentials and may also identify the payment transaction, a merchant, date and time, a value of the transaction, and/or whether the one or more pseudo credentials are limited to that particular merchant, a type of merchant (e.g., transit, vending machine, and the like), a particular period of time (e.g., for all transaction during the following week), and the like. FIG. 8 provides examples of an e-mail and text communication. In some embodiments, additional steps to ensure further security of the communications with the consumer concerning the pseudo credentials are taken, such as requiring a password to access the communications and/or encrypting the communications.

Finally, at step 370, the issuer transmits the authorisation response towards the merchant. Although FIG. 3A depicts the method steps in a certain order, the steps may be performed in a different order. That is, some steps may be performed in a different order and/or executed substantially parallel or substantially contemporaneously to each other. For example, in some embodiments, step 330 is performed prior to step 320, and/or step 370 is performed prior to step 350.

The method for processing payment transactions described with respect to FIG. 3A is not limited to being performed by the issuer only. Rather, in some embodiments, the method is performed by the payment system network, such as MasterCard™, or by another payment system facilitator (e.g., at and by processing hubs, computer systems and/or the like maintained by the payment system network or payment facilitator). FIG. 3B shows such a variation, according to some embodiments. In particular, FIG. 3B depicts a method 300B for processing payment transactions in which the payment system network provides on-behalf services to issuer(s) concerning issuance and maintenance of pseudo credentials for customers (account holders) of the issuer(s). Yet, in some embodiments, the method for processing payment transactions is performed by a combination of different parties, e.g., the payment system network generates and maintains pseudo credentials, whilst each particular issuer is responsible for providing such pseudo credentials to their respective consumers.

Returning to FIG. 3B, the steps of the method 300B that are generally performed in a manner similar to that of the steps of the method 300A of FIG. 3A, although by a different party, are identified using the same reference numbers as in FIG. 3A. The method 300B starts with step 310 where the payment system network receives an authorisation response from an issuer concerning a payment transaction initiated at an unattended payment terminal. The authorisation response includes credentials associated with a payment device used to initiate the payment transaction and read from that payment device.

At step 315, the payment system network determines whether pseudo credentials are required for the consumer that has conducted the payment transaction. As discussed for example with respect to FIG. 2B, in some embodiments, the payment system network maintains a database for its on-behalf service subscribers of customers' accounts requiring pseudo credentials. In these embodiments, the payment system network determines whether the one or more pseudo credentials are required, for example, by searching the database based on the PAN of the payment device, such as described with respect to FIG. 2B, or in manner similar to that of the issuer, as described with respect to FIG. 3A. In some embodiments, however, whether the pseudo credentials should be issued is indicated to the payment system network by the issuer, for example, using a respective indicator inserted into the authorisation response. In such embodiments, step 315 of the method 300B includes the payment system network evaluating such an indicator to determine whether the one or more pseudo credentials should be issued.

If at step 315, the payment system network determines that no pseudo credentials need to be issued, then the method 300B proceeds to step 370, at which the payment system network forwards/transmits the received authorisation response to the merchant. However, if the pseudo credentials are required, the payment system network issues, at step 320, one or more pseudo credentials. Similar to the method 300A discussed with respect to FIG. 3A, if the pseudo credentials are generated in real time, the method further includes step 325 of storing such pseudo credentials in association with the account holder (customer's account), for example in the database of the payment system network. However, if the one or more pseudo credentials are pre-generated and stored in the payment system network's database prior to receipt of the authorisation response, step 320 merely includes obtaining (retrieving) pseudo credentials, for example, from the database.

At step 345, the payment system network updates the authorisation response to include the one or more pseudo credentials into the response. In some embodiments, certain field(s) of the authorisation response are specifically designated for providing the one or more pseudo credentials and are updated accordingly. At step 350, the payment system network communicates or otherwise provides the one or more pseudo credentials to the customer associated with the payment credentials, generally in the manner described with respect to FIGS. 2A and 3A. Finally, the method proceeds to step 370 at which the updated authorisation response is transmitted to the merchant.

Although FIG. 3B depicts the method steps in a certain order, the steps may be performed in a different order. That is, some steps may be performed in a different order and/or executed substantially parallel or substantially contemporaneously to each other. For example, in some embodiments, step 320 is performed prior to step 310 and step 315 is performed using data from an authorisation request received by the payment system network from the merchant. Further, in some embodiments, the payment system network does not communicate the one or more pseudo credentials to the consumer. Instead the payment system network communicates the one or more credentials to the issuer, who in turn communicates them to the consumer.

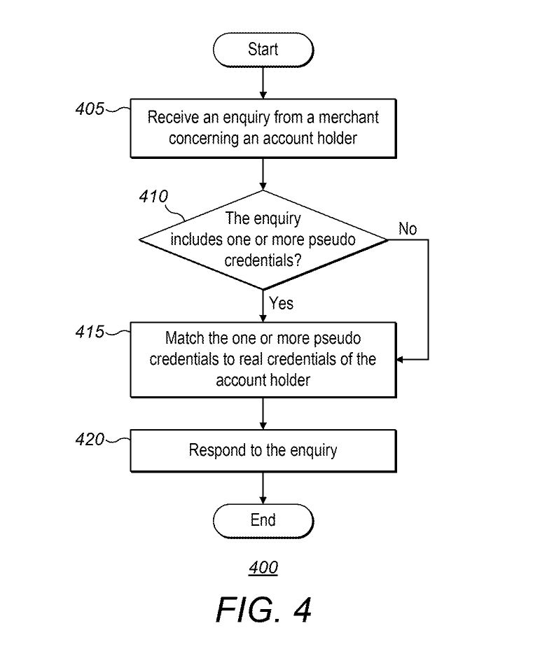

FIG. 4 shows a flow diagram of a method 400 for responding to an enquiry from a merchant, according to some embodiments. The method 400 may be performed by an issuer or by a payment system network providing on-behalf services to one or more issuers concerning issuance and maintenance of pseudo credentials for consumers of the one or more issuers. The method 400 may also be performed by a payment transaction facilitator, such as an acquirer.

At step 405, the issuer or the payment system network receives an enquiry, sent by a merchant, concerning an account serviced by the issuer, for example, an account status enquiry or a debt recovery transaction. An account status enquiry transaction would typically relate to a customer's enquiry concerning one or more past transactions with a particular merchant. An account status enquiry may also relate to a request by the customer to register with the merchant. To register the consumer, the merchant needs to confirm customer's identity and authenticity of the customer's payment device, and thus is required to contact the issuer. The account status enquiries are usually non-financial. A debt recovery transaction is, on the other hand, a financial transaction. Such transactions typically involve a merchant attempting to recover money owned by a particular customer, for example, in a scenario where the consumer has been granted an entry to transit services prior to transaction's authorisation, but the issuer subsequently declined to authorise the transaction. Effectively, the customer was allowed to travel without a respective payment being collected, and thus now owes money to the transit agency for his or her travels. The customer may have also been blocked by the merchant from further use of the services.

For either of these transaction types, the transit agency enquiry may include one or more pseudo credentials that has been previously provided to the transit agency by the issuer or on behalf of the issuer in connection with a corresponding consumer, for example, in response to an authorisation request concerning a payment transaction at an unattended terminal. To safeguard customer's data, such as financial and personal data, the issuer may require the merchant to include additional information concerning the respective customer in such enquiries, for example, a billing address and/or a secure code.

At step 410, the issuer (payment system network) determines whether the enquiry includes one or more pseudo credentials. For example, in some embodiments the issuer (payment system network) maintains a list (a table, a database, or the like) of customers (payment devices) for whom pseudo credentials have been issued and/or corresponding pseudo credentials and accesses such a list to confirm whether the pseudo credentials were issued. In some other embodiments, the enquiry includes an indication (indicator, or the like), such as a flag in a particular enquiry field, that the enquiry includes pseudo credentials.

Other arrangements may be used as well. For example, if the method 400 performed by the issuer, the issuer may simply access data associated with the consumer directly using the pseudo credentials. In yet another example of the method being performed by the issuer, the payment system network proceeds to determining whether the enquiry includes pseudo credentials only if it first determines that the enquiry is directed to an issuer who has subscribed to the on-behalf services of the payment system network.

If the enquiry does not include one or more pseudo credentials, the enquiry is processed in a regular manner, such as described with respect to FIG. 1. However, if a determination is made that the enquiry does include pseudo credentials, the issuer (payment system network), at step 415, matches the received pseudo credentials to real credentials. In some embodiments, this step simply requires the issuer (payment system network) to look up the real credentials corresponding to the pseudo credentials. For example, the issuer payment system network may maintain a database (a table in a database, or the like) for storing real and pseudo credentials in association with each other and/or respective customers. In some embodiments, the issuer (payment system network) stores pseudo credentials issued for a particular customer together with other data concerning that customer's account, for example, within specially assigned fields of the customer's personal record(s) and/or his or her transactional (financial) records. In some other embodiments, steps 410 and 415 are merged. That is, when the issuer (payment system network) searches (analyses, or otherwise considers) its list (table, database, or the like) to determine whether the enquiry includes pseudo credential(s), upon successfully locating a respective customer record, it also accesses the corresponding real credentials.

Step 420 varies depending on whether the method 400 is performed by the issuer or by the payment system network. In particular, when the method 400 is performed by the payment system network (or some payment facilitator), the payment system network, in addition to its regular responsibilities, also serves as a kind of “translator” for communications between the merchant and the issue with respect to payment device credentials. If the payment network system has been able to determine the real credentials corresponding to the received pseudo credentials at step 415, then the payment system network, at step 420, updates the received enquiry with the real credentials (e.g., by replacing the pseudo credential(s) with the corresponding real credential(s)), forwards the updated enquiry to the issuer, and upon receiving the issuer's response, updates the response with the pseudo credentials and forwards the updated response to the sender of the enquiry, i.e., the merchant. If the payment network system has not been able to successfully match the pseudo credentials to the real credentials at step 410, the payment system may transmit a response indicating unsuccessful authentication to the merchant on behalf of the issuer, or alternatively forward the enquiry to the issuer. For example, the customer may have actually provided his or her real credentials, even though the pseudo credentials have been issued and the issuer may choose to accept such credentials for authentication.

When the method 400 is performed by the issuer, the issuer authenticates the consumer/payment device based on the matched real credentials and any additional customer's information that has been submitted with the enquiry, such as a billing address, and responds to the enquiry accordingly by providing a response to the sender of the enquiry. The enquiry response however includes the pseudo credentials. Further, if needed, the issuer performs any changes concerning the customer's account relevant to the merchant's enquiry, such as clearing and settling the payment transaction with the merchant in case of a debt recovery transaction. In some embodiments, the issuer uses the pseudo credentials to directly access at least some of the data associated with the consumer's account (e.g., when the pseudo credentials are stored in additional fields of the records associated with the consumer's account). If the issuer is not able to locate the real credentials corresponding to the received pseudo credentials, authentication of the customer's account/payment device will be deemed unsuccessful.

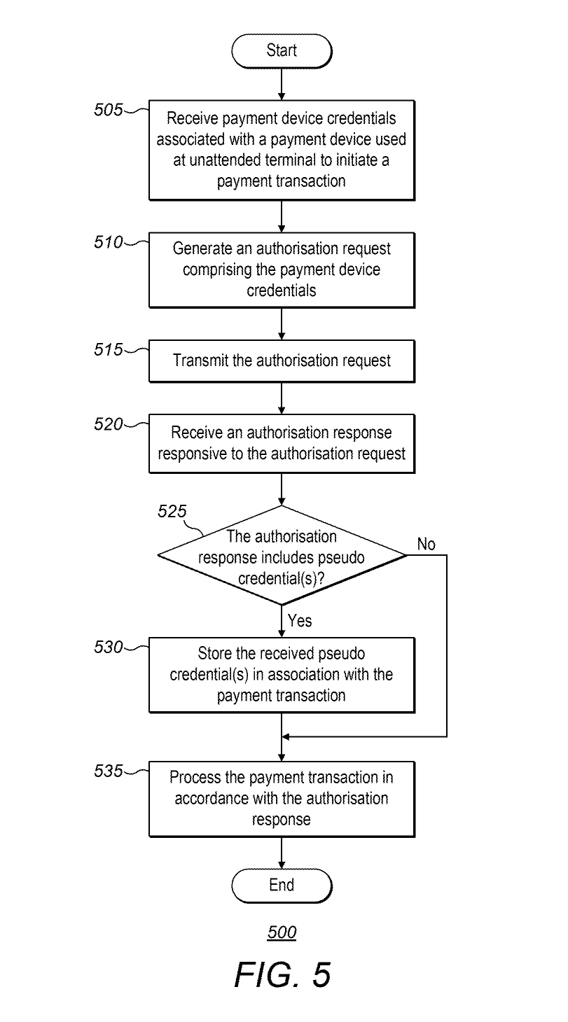

FIG. 5 illustrates a flow diagram of a method 500 for processing, by a merchant, e.g., a transit agency, a payment transaction at an unattended payment terminal, according to some embodiments. The method 500 starts at step 505 with the merchant receiving credentials associated with a payment device used at the unattended payment terminal to initiate the payment transaction. For example, the unattended terminal may have a reader, which reads the credentials from a smart chip or NFC chip of the payment device when the consumer taps the payment device against the reader or from a magnetic strip when the consumer swipes the payment device through the reader. The terminal then transmits the credentials acquired from the payment device to the back end computers of the merchant. The merchant may receive all or only some credentials (such as the key credentials discussed above) available on the payment device. Which credentials the merchant receives may depend on technical specifications of the terminal, a particular arrangement between the merchant, the acquirer, the payment system network, and/or the issuer and/or the rules of the payment system network.

At step 510, the merchant generates to the issuer an authorisation request concerning the payment transaction. The authorisation request includes at least some of the credentials read from the payment device. The authorisation request may also include the amount of the payment transaction, an aggregation amount, or a nominal amount. The authorisation request may further include information identifying the transaction, such as the merchant, the merchant's category, the date, the time, and/or the location of the unattended terminal, and/or like. Upon generating the authorisation request, the merchant transmits such a request to its acquirer for transmission to the respective issuer via the payment system network. The authorisation request is processed in the manner, for example, described with respect to FIGS. 3A and 3B, resulting in an authorisation response being generated for and provided to the merchant.

The merchant receives the issuer's authorisation response responsive to the authorisation request at step 520. If the authorisation response includes one or more pseudo credentials (step 525), at step 530, the merchant stores the received one or more pseudo credentials in association with the payment transaction, the consumer, consumer's payment device, and/or the consumer's account. The merchant, such as a transit agency, may also link/associate the received pseudo credentials to/with subsequent transactions initiated by the same payment device. The merchant then processes the payment transaction based on the received authorisation response. For example, some merchants await an authorisation response to determine whether to grant access to their services or goods, such as to release a bike from a bike rental terminal to a user. Then, depending on whether the authorisation response indicates that the payment transaction was approved (authorised, or the like) or denied (declined, or the like), the user is allowed or not allowed to obtain a bike. Some merchants however grant access to their services or goods before receiving an authorisation response, e.g., transit agencies. Then, if the authorisation response indicates that the payment transaction was approved, the merchant updates the corresponding transaction records accordingly, and the consumer is able to continue traveling with that transit agency, i.e., to leave the transit network at the end of his/her journey, embark on another journey within the same network, and/or the like. If however the authorisation response indicates that the payment transaction was denied, the transit agency may prevent the consumer from leaving the transit network (e.g., not opening an exit gate in response to the consumer taping his or her payment device when attempting to exit the transit network), and/or place the consumer on a black (blocked, or the like) list so that the consumer is not allowed to travel within this transit agency's network until the transaction is cleared and settled, such as via a debt recovery transaction.

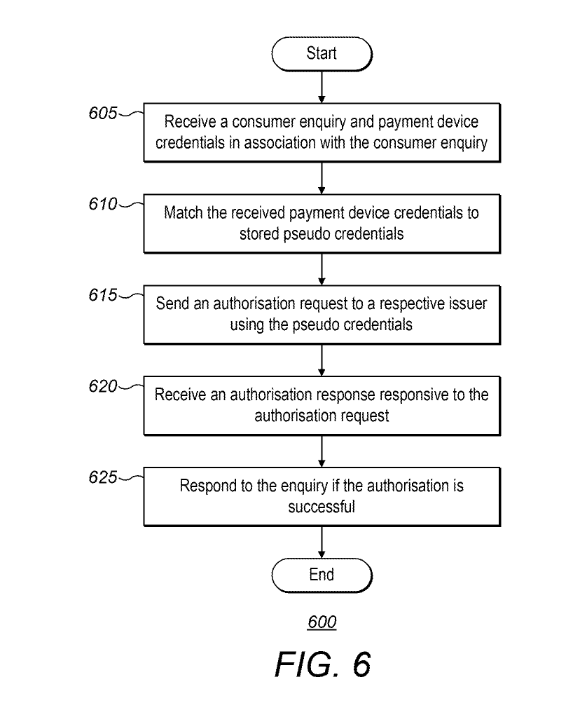

FIG. 6 depicts a flow diagram of a method 600 for responding by a merchant to an enquiry from a consumer, according to some embodiments of the invention. The method 600 starts at step 605 when the merchant receives an enquiry from the consumer along with the payment device credentials. For example, the consumer may enquire of the merchant about a particular payment transaction conducted at a merchant's unattended terminal, a transaction history with that merchant, or an account status, request to register with the merchant such as for an online account with the merchant, place an ecommerce, mail, or telephone order, and the like. The consumer may submit the enquiry and the payment device credentials, such as a PAN, CVC2, and an expiry date online, e.g., at a merchant's website, or by calling the merchant's call centre. To enhance security of the enquiry processing, the merchant may also request additional identifying information from the consumer, such as a billing address and/or a secure code. Depending on the method used by the consumer to submit the enquiry, the consumer may be offered to enter the requested credentials online, using a telephone in response to prompts by an automated system, or the like.

As discussed herein, in accordance to some embodiments, when the consumer's payment device does not have visible payment device credentials, the user is issued and provided with pseudo credentials, for example, in association with the payment transaction with the merchant. Thus, in such embodiments, when the consumer submits an enquiry to the merchant, the payment device credentials that would accompany such an enquiry at step 610 will typically be pseudo credentials previously provided to the consumer in association with the payment transaction. Thus, at step 615, the merchant compares (matches) the payment device credentials received from the consumer to pseudo device credentials that the merchant has previously received from the issuer (or payment network system) in association with the payment transaction. Since at the time of the payment transaction, the merchant has linked the pseudo credentials to the real credentials of the consumer, as described herein, responsive to the consumer enquiry, the merchant is able to access, based on the received pseudo credentials, all transactions associated with the consumer's payment device and performed using the real credentials of the payment device.

To respond to the consumer's enquiry, the merchant typically is required to submit an authorisation request to a respective issuer to authenticate the consumer's payment device/account. In accordance with the method 600 of FIG. 6, the merchant generates an authorisation request that includes the pseudo credentials submitted by the consumer and sends the authorisation request to the issuer such as via the merchant's acquirer (bank) and the payment system network at step 615.

The authorisation request is processed and a respective authorisation response is generated, for example, in the manner described with respect to FIG. 5. The merchant receives the authorisation response at step 620, and if the authorisation is successful—that is, the consumer's accounts/payment device has been authenticated—the merchant responds to the consumer's enquiry. The merchant may need to locate consumer data responsive to the enquiry (e.g., past transaction), make changes to the consumer data (e.g., clear a particular payment transaction), remove the consumer from the blocked/black list so as to enable the consumer to use merchant's services, and the like. The merchant performs such actions using the pseudo credentials of the consumer. For example, if the consumer has requested his or her payment transaction history, the merchant is able to access such a history by matching the pseudo credentials to the real credentials (as discussed with respect to step 610) and then accessing all the transactions that have been initially processed using the real payment device credentials. That is, the merchant first matches the pseudo credentials to the real credentials, and then accesses the consumer data using the real credentials. In some embodiments, however, the merchant accesses the consumer data directly using the pseudo credentials.

If the authorisation response indicates that the identity of the payment device/account has not been confirmed (the payment device or account has not been authenticated), the merchant provides no information responsive to the consumer's enquiry, but rather denies the enquiry.

Although the method 600, as described, focuses on the scenario where the consumer provides the one or more pseudo credentials he or she previously received, in some embodiments, the consumer may submit to the merchant his or her real credentials instead. Depending on a particular policy or agreement between the merchant, the issuer, and/or the payment system network, the merchant and/or the issuer may authenticate or not authenticate the consumer's account/payment device based on the real credentials when the one or more pseudo credentials have been previously issued for the consumer.

As discussed herein, in some circumstances, not a full set of pseudo credentials may be provided to the merchant in response to an authorisation request concerning a particular transaction. For example, when a payment device used to initiate the transaction does not show only some of the device credentials (e.g., a PAN), the issuer may provide only pseudo credential corresponding to the missing (not-shown) device credentials (e.g., a pseudo PAN). If, subsequently, a consumer submits an enquiry concerning the transaction or associated services, the merchant compares credentials submitted by the consumer to a mix of pseudo and real credentials for the authentication purposes. In particular, it uses the pseudo credentials provided by the issuer (in the example above, a pseudo PAN) and real credentials for the types of credentials not provided by the issuer (in the example above, an expiry date and CVC2 read by the merchant from the payment device).

Although only a single exchange between the consumer and the merchant (steps 605 and 620) and between the merchant and the issuer (steps 615 and 620) concerning the enquiry itself is shown in FIG. 6, the skilled person would appreciate that addressing the consumer enquiry may require further exchanges between the consumer and the merchant and/or the merchant and the issuer. Further, the consumer may submit more than one enquiry during the enquiry session with the merchant. Under such circumstances, in some embodiments, the merchant confirms the consumer's identity using the pseudo credentials only once, in the beginning of the enquiry session.

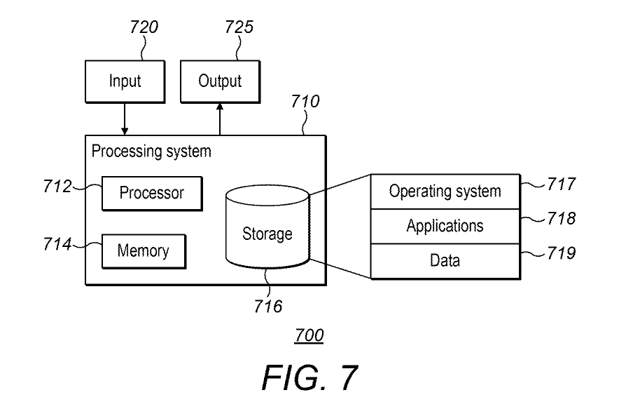

FIG. 7 depicts an example of a system 700 that facilitates the processing of payment transactions at unattended terminals in accordance with embodiments of the present invention, such as the embodiments described in respect of FIGS. 2A to 6. The system 700 includes a processing system 710 (processing hub, server, or the like) comprising processor(s) 712, memory 714, and storage device(s) 716. Furthermore, the processing system 710 is coupled to input device(s) 720, such as a keyboard, a mouse, a touchscreen, a microphone, or the like, and output device(s) 725 such as a display, a speaker, and the like. The storage device 716 stores an operating system 717, application(s) 718, and data 719.

The application(s) 718 can include instructions, which when executed by the processing system 710, can cause the system 710 to perform/execute methods, operations, and/or processes described above with respect to FIGS. 2A to 6. For example, the application(s) 718 can include instructions for processing payment transactions by a merchant, if the system 700 is implemented on the merchant's side, or instructions for processing payment transactions by an issuer, a payment system network, or another payment processing facilitator, if the system 700 is implemented respectively on the issuer's side, the payment system network, or the other payment processing facilitator's side.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, CDs (compact discs), DVDs (digital versatile discs), or other media that are capable of storing code and/or data.

The methods and processes can also be partially or fully embodied in hardware modules, apparatuses, or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

The order of execution or performance of the operations in the embodiments illustrated and described herein is not essential, unless otherwise specified. That is, the operations/steps may be performed in any order, unless otherwise specified, and embodiments may include additional or fewer operations/steps than those disclosed herein. For example, a particular selected order of steps of methods described in relation to FIGS. 3A to 6 may depend on preferences and/or technical specifications of the parties involved in the payment transaction processing. It is further contemplated that executing or performing a particular operation/step before, contemporaneously with, or after another operation is in accordance with the described embodiments.

While the invention has been described in terms of various specific embodiments, the skilled person would recognize that the invention can be practiced with modification within the spirit and scope of the claims.

What is claimed is:

1. A computer-implemented method for processing, at a processing hub, transactions initiated at unattended terminals, the method comprising:
receiving, at the processing hub, authorisation request data from a first party concerning a transaction initiated at an unattended terminal of the first party, the authorisation request data comprising real credentials of a user device used to initiate the transaction;
issuing, by the processing hub, one or more pseudo credentials for a user associated with the real credentials;
transmitting authorisation response data responsive to the authorisation request data from the processing hub toward the first party, the authorisation response data comprising the one or more pseudo credentials; and
communicating the one or more pseudo credentials to the user.

2. The method according to claim 1, wherein issuing the one or more pseudo credentials comprises one of:
generating the one or more pseudo credentials in response to receiving the authorisation request data and storing the one or more pseudo credentials in association with the user device; or
retrieving, from storage, based on the real credentials, the one or more pseudo credentials associated with the user device.

3. The method according to claim 1, wherein the processing hub is configured to generate and maintain pseudo credentials on behalf of one or more second parties, the one or more second parties comprising an issuer of the user device.

4. The method according to claim 3, further comprising:
forwarding the received authorisation request data from the processing hub toward the issuer;
receiving, from the issuer, the authorisation response data responsive to the authorisation request data; and
updating the authorisation response data to include the one or more pseudo credentials, prior to transmitting the authorisation response data toward the first party.

5. The method according to claim 3, further comprising:
receiving, at the processing hub, an enquiry authorisation request data from the first party concerning the user device, the enquiry comprising the one or more pseudo credentials;
matching, by the processing hub, the one or more pseudo credentials to the real credentials of the user device;
updating, by the processing hub, the enquiry authorisation request data with the one or more pseudo credentials; and
transmitting, from the processing hub, the updated enquiry authorisation request data toward the issuer of the user device.

6. The method according to claim 5, further comprising:
receiving, from the issuer, an enquiry response data responsive to the updated enquiry authorisation request data;
updating the enquiry response data with the one or more pseudo credentials; and
transmitting the updated enquiry response data toward the first party.

7. The method according to claim 5, wherein the unattended terminal is one of: a transit agency terminal, a parking terminal, a rental terminal, or a vending machine.

8. The method according to claim 1, wherein an issuer of the user device maintains the processing hub, the method further comprising:
receiving, at the processing hub, from the first party, an enquiry authorisation request data concerning the user device and comprising the one or more pseudo credentials;
matching, by the processing hub, the one or more pseudo credentials to the real credentials of the user device;
accessing, at the processing hub, data related to the enquiry authorisation request data using the real credentials to generate, by the processing hub, an enquiry response data responsive to the enquiry authorisation request data; and
transmitting, from the processing hub, the enquiry response data toward the first party.

9. The method according to claim 1, wherein use of the one or more pseudo credentials is restricted to one or more of: the first party, a type of the first party, a type of the transaction, or a time frame.

10. The method according to claim 1, wherein the one or more pseudo credentials comprise at least one of a pseudo primary account number, a pseudo expiry date, a pseudo card verification code, a pseudo name, a pseudo address, or one or more pseudo security codes.

11. The method according to claim 1, wherein communicating comprises at least one of:
sending an e-mail message comprising the one or more pseudo credentials to an e-mail address associated with the user;
sending a text message comprising the one or more pseudo credentials to a phone number associated with the user;
providing a computer-generated voice notification comprising the one or more pseudo credentials to the phone number associated with the user; or
making the one or more pseudo credentials available for access by the user via an application used by the user to access data concerning a user's account, wherein the application is a web-based application or an application downloaded on at least one device of the user.

12. The method according to claim 1, wherein:
the transaction is a payment transaction;
the first party is a merchant;
the user is a customer of the merchant;
the user device is a contactless payment device; and
the processing hub is maintained by a second party, wherein the second party is one of: an issuer of the payment device or a payment system network configured to facilitate processing of at least payment transactions associated with the issuer of the payment device.

13. A processing hub for processing transactions initiated at unattended terminals, the processing hub comprising:
a memory configured to store data associated with the transactions initiated at the unattended terminals, the memory further storing instructions; and
at least one processor configured to, when executing the instructions stored in the memory, cause the processing hub to:
receive first authorisation request data from a first party concerning a transaction initiated at a first unattended terminal of the first party, the first authorisation request data comprising real credentials of a user device used to initiate the transaction;
issue one or more first pseudo credentials for a user associated with the real credentials;
transmit first authorisation response data responsive to the first authorisation request data from the processing hub toward the first party, the first authorisation response data comprising the one or more pseudo credentials; and
communicate the one or more pseudo credentials to the user,
wherein the memory is further configured to store data mapping the one more first pseudo credentials to the real credentials.

14. The processing hub according to claim 13, wherein the at least one processor is further configured to cause the processing hub to:
receive second authorisation request data from a second party, different from the first party, concerning a second transaction initiated at a second unattended terminal of the second party by the user device, the authorisation request data comprising the real credentials of the user device;
issue, for the user, one or more second pseudo credentials, different from the one or more first pseudo credentials;
transmit second authorisation response data responsive to the second authorisation request data from the processing hub toward the second party, the authorisation response data comprising the one or more second pseudo credentials; and
communicate the one or more second pseudo credentials to the user,
wherein the memory is further configured to store data mapping the one more second pseudo credentials to the real credentials.

15. A computer-implemented method for processing transactions initiated at unattended terminals associated with a first party, the method comprising:
receiving, at a server of the first party, from an unattended terminal associated with the first party, real credentials of a user device used to initiate a transaction at the unattended terminal;
generating, by the server, authorisation request data concerning the transaction, the authorisation request data comprising the real credentials;
transmitting, from the server, the authorisation request data toward a second party;
receiving, from the second party, authorisation response data responsive to the authorisation request data, the authorisation response data comprising one or more pseudo credentials;
processing the transaction in accordance with the authorisation response data; and
storing the one or more pseudo credentials in association with the processed transaction.

16. The method according to claim 15, further comprising:
receiving an enquiry concerning the user device, the enquiry comprising the one or more pseudo credentials;
generating, by the server, enquiry authorisation request data in association with the enquiry, the enquiry authorisation request data comprising the one or more pseudo credentials;
transmitting, from the server, the enquiry authorisation request data toward the second party; and
receiving, from the second party, enquiry authorisation response data responsive to the enquiry authorisation request data.

17. The method according to claim 16, further comprising in response to receiving the enquiry authorisation response data at least one of:
removing, by the server, the user device from a blocked list, wherein the blocked list identifies user devices forbidden to access services of the first party;
providing, from the server, a transaction history of the user device with the first party to a sender of the enquiry;
providing, from the server, data concerning the transaction to the sender of the enquiry; or
registering a user of the user device with the first party.

18. The method according to claim 16, wherein the enquiry is one of an account status enquiry or a debt recovery transaction.

19. The method according to claim 15, further comprising:
receiving, at the server, from one of the unattended terminals associated with the first party, the real credentials of the user device when the user device is used to initiate a subsequent transaction with the first party; and
associating the subsequent transaction with the one or more pseudo credentials.

20. The method according to claim 15, wherein the transaction is a payment transaction, the first party is a merchant, the user device is a payment device, the user is a customer of the merchant, and the second party is one of an issuer of the payment device or a payment system network configured to facilitate processing of at least payment transactions associated with the issuer of the payment device.
